(19) United States
(12) Patent Application Publication
(10) Pub. No.: US 2016/0140515 A1
(43) Pub. Date: May 19, 2016

(54) TASK-DIRECTING SYSTEM AND TASK-DIRECTING METHOD

(71) Applicant: HITACHI, LTD., Tokyo (JP)

(72) Inventors: Daisuke KATSUMATA, Tokyo (JP); Kenji TAMAKI, Tokyo (JP); Hiroyuki MAGARA, Tokyo (JP); Ryoji ASAKURA, Tokyo (JP)

(21) Appl. No.: 14/899,234

(22) PCT Filed: Sep. 13, 2013
(86) PCT No.: PCT/JP2013/074794

§ 371 Date: Dec. 17, 2015

(51) Int. Cl. G06Q 10/00; G06Q 10/06

(52) U.S. Cl. CPC G06Q 10/20; G06Q 10/06315

(57) ABSTRACT

A task-directing system that directs tasks for the purposes of repairing a device and including a storage unit, a processing unit, and an output unit wherein: the storage unit contains a diagnostic-information storage unit and a repair-probability storage unit; the diagnostic-information storage unit stores diagnostic information, said diagnostic information comprising a plurality of levels containing diagnostic tasks and action tasks for the purposes of repair, and the duration or cost of each task; for each action task, the repair-probability storage unit stores a repair probability indicating the probability that the device would be repaired by said action task; the processing unit has a repair-probability update unit and an optimal-task computation unit; on the basis of input diagnostic-task results, the repair-probability update unit updates the repair probabilities stored in the repair-probability storage unit.

### TECHNICAL FIELD

The present invention relates to a task-directing system for repairing a device.

### BACKGROUND ART

To maintain the quality of a manufacturing device or an inspection device for a long time, it is necessary to perform an appropriate measures-task when a failure is generated. An increase in the service level, which is achieved by accurately and efficiently performing a measures-task at failure generation time and reducing the downtime through measures-tasks such as required part-replacement, contributes to getting more orders. To diagnose the cause of a failure, it is common to use a diagnostic decision tree and to start diagnosing the failure from the highest layer of the diagnostic decision tree. However, the problem with this method is that it takes long to solve the failure. A diagnostic decision tree, structured as a binary tree, has a node, which indicates the symptom of a failure, in the highest layer and a node, which indicates an action task candidate for repairing the failure, in the lowest layer. In an intermediate layer, a diagnostic decision tree has a node that indicates a diagnostic task for identifying an appropriate action task for the symptom of the failure. A node indicating a diagnostic task has two child nodes corresponding to the diagnostic result for Yes and that for No.

As the background technology in this technical field for solving this problem, JP-A-2007-193456 (Patent Literature 1) is disclosed. This literature describes that, when a human or a machine performs a failure diagnostic task according to a diagnostic decision tree, the change amount of the repair probability, a probability with which a target device is repaired by a candidate action task, is computed and an instruction to perform the task can be issued in the descending order of change amounts, that is, in the descending order of task efficiency.

### CITATION LIST

### Patent Literature

PATENT LITERATURE 1: JP-A-2007-193456

### SUMMARY OF INVENTION

### Technical Problem

In the conventional technology, the problems given below remain unsolved. Because the technology disclosed in Patent Literature 1 assumes that the result of each diagnostic task is correct with no consideration for the possibility that the result of the diagnostic task is incorrect, the device cannot be repaired or it takes long to repair the device when the diagnostic task is incorrect. For example, a determination as to whether there is an abnormal sound depends on operators who work on that task. In addition, when a determination is made based on data obtained from a sensor, the determination may be incorrect due to an error or a variation if the value of data is near to the threshold used as the criterion for the determination.

In the conventional technology, the above-described problem is generated because an action, not selected as a result of the determination in a diagnostic task, is determined not to be performed.

Therefore, it is an object of the present invention to provide a system that, taking into account the possibility that diagnostic-task results could be incorrect, presents an optimal task sequence to a measures-taking operator or operator in terms of repair time or repair cost.

### Solution to Problem

To solve the above problems, the configuration described in claims is used. The present application includes a plurality of means for solving the above problems. One of them is
a task-directing system that presents a task for repairing a device, the task-directing system characterized by including:
a storage unit that includes a diagnostic information storage unit that stores diagnostic information composed of a plurality of layers each including a diagnostic task and an action task for repairing and a task time or a task cost of each task; and a repair probability storage unit that stores a repair probability, the repair probability being a probability with which the device will be repaired by performing each action task;
a processing unit that includes a repair probability update unit that updates the repair probability stored in the repair probability storage unit based on a result of the diagnostic task that is received; and an optimal task computation unit that computes a priority task from the updated repair probability and the task time or the task cost of each task; and
an output unit that outputs information on the priority task computed by the optimal task computation unit.

### Advantageous Effects of Invention

According to the present invention, a failure diagnostic task sequence, appropriate in terms of repair time and repair cost, may be presented for use failure diagnosis performed when a failure is generated in a device.

### BRIEF DESCRIPTION OF DRAWINGS

FIG. 1 is an example of an embodiment of a measures task-directing system.

FIG. 2 is an example of the configuration diagram of the measures task-directing system.

FIG. 3 is an example of the hardware configuration of an information terminal.

FIG. 4 is an example of the data table in an input-information storage unit.

FIG. 5 is an example of the data table in a diagnostic decision tree master information storage unit.

FIG. 6 is an example of the data table in a repair probability information storage unit.

FIG. 7 is an example of the data table in an optimal task storage unit.

FIG. 8 is an example of the data table in a basic configuration block storage unit.

FIG. 9 is an example of the data table in a measures-task information storage unit.

FIG. 10 is an example of the data table in a sensor information storage unit.

FIG. 11 is an example of the data table in an alarm information storage unit.

FIG. 12 is an example of the flowchart of the measures-task direction processing.

FIG. 13 is a diagram showing the operation of a diagnostic decision tree.

FIG. 14 is an example of the flowchart of the input information processing.

FIG. 15 is a diagram showing the basic configuration block.

FIG. 16 is an example of the flowchart of the optimal task computation processing.

FIG. 17 is an example of the flowchart of the optimal task computation processing.

FIG. 18 is an example of the output screen of the measures task-directing system.

FIG. 19 is an example of the output screen of the measures task-directing system.

FIG. 20 is an example of the flowchart of the repair probability update processing.

FIG. 21 is an example of the flowchart of the diagnostic decision tree master information update processing.

FIG. 22 is an example of the flowchart of the measures-task direction processing.

FIG. 23 is an example of the data table in a sensor information storage unit.

FIG. 24 is an example of the flowchart of the sensor information reception processing.

FIG. 25 is an example of the output screen of the measures task-directing system.

FIG. 26 is a diagram showing the relation between a sensor value and a determination confidence level.

### DESCRIPTION OF EMBODIMENT

Embodiments are described below with reference to the drawings.

### First Embodiment

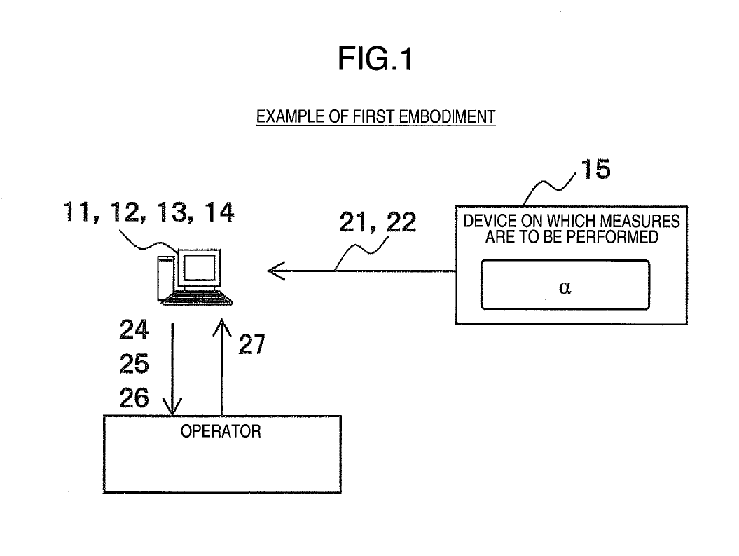

An embodiment of the present invention is described below with reference to FIG. 1. Although a measures task performed when a device fails is described in this embodiment, the present invention is not limited to a measures task performed at that time but is applied to the general measures performed when a failure occurs. A measures task-directing system determines whether to perform a measures task using, as a trigger, the value of sensor data 22, obtained from the sensors installed on a measures-target device, or alarm information 23, automatically issued when the measures-target device is determined to be abnormal based on the value of the sensor data 22. If a measures task is necessary, appropriate measures task direction 24, expected repair time 25, and expected repair cost 26 are presented to an operator and a necessary measures task for the measures-target device is performed while referencing a directed task. Here, the expected repair time refers to an expected time to the repair of the failure and the expected repair cost refers to an expected cost required to repair the failure. The operator enters a task result 27 of the performed task, and a measures task-directing system 11 updates the repair probability of each action and serially presents an appropriate measures task direction, expected repair time, and expected repair cost.

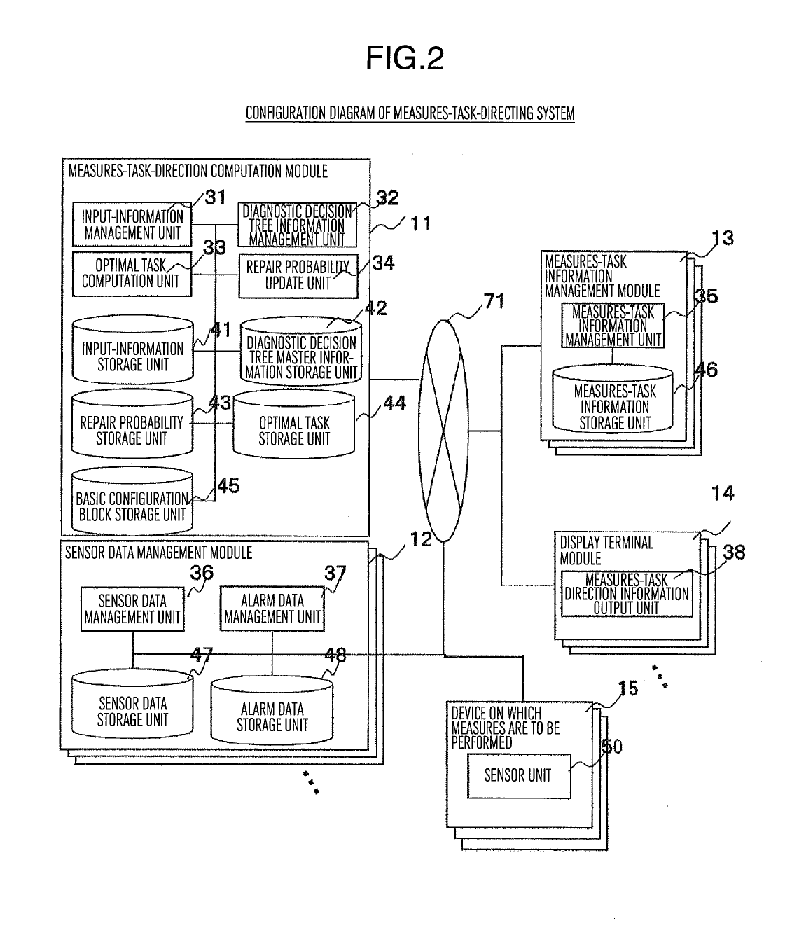

FIG. 2 is an example of the configuration diagram of a measures task-directing system in this embodiment. In a failure diagnosis performed when a measures-target device fails due to wear or deterioration and a measures task is required for the measures-target device, the measures task-directing system updates the repair probability, which is a probability with which the measures-target device will be repaired by a necessary repair action, based on the result obtained when the measures task is performed, computes the expected repair time and the expected task cost using the updated repair probability, and presents the optimal task sequence, which minimizes the time and the cost, to the operator.

The measures task-directing system is configured by a measures-task direction computation module 11 that manages a diagnostic decision tree and computes an optimal diagnostic task sequence based on the diagnostic decision tree when a failure is generated, a sensor data management module 12 that manages data, acquired from the sensors installed on a target device, and sends alarm information to the support center when the sensor data indicates an abnormal value, a measures task information management module 13 that manages the measures task results and the task time when a measures task is performed, and a display terminal module 14 that outputs an appropriate measures task on the measures task direction terminal, which presents information to each operator, when a failure is generated. Here, the measures task result refers to the result Yes or No when the measures task is a diagnosis and refers to the result Repaired or Not Repaired when the measures task is an action, and the task time refers to the time required for each measures task.

The configuration modules 11 to 14 are each connected to a network 71, and the information terminals 11 to 14 can send and receive various types of data with each other via the network 71. A measures-target device 15, which has a sensor unit 50, is also connected the network 71 to send and receive sensor data to and from each information terminal.

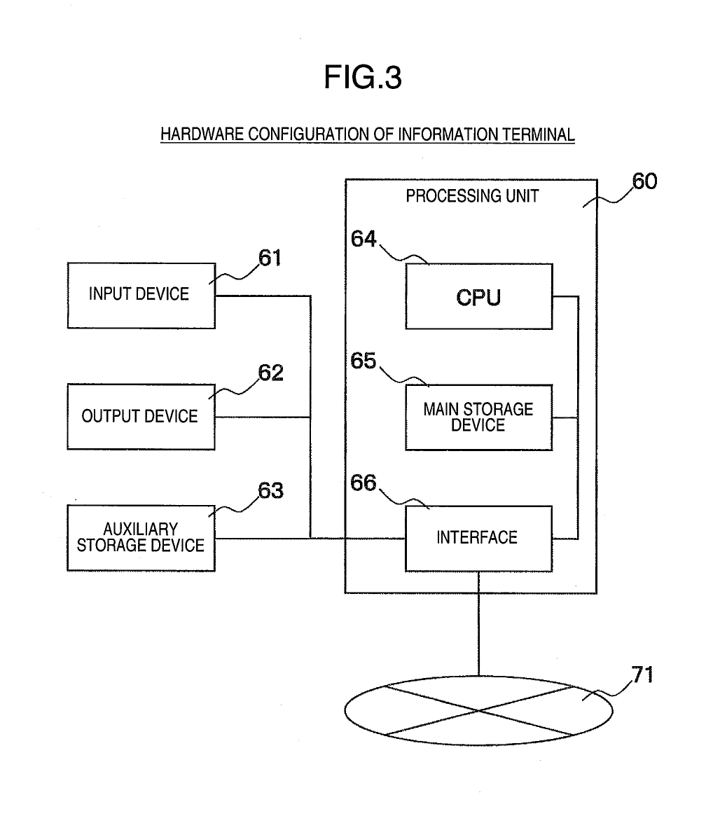

As shown in FIG. 3, each of the configuration modules 11 to 14 is a computer that has an input device 61 such as a keyboard or a mouse, an output device 62 such as a display, an auxiliary storage device 63, and a processing unit 60 that executes various types of programs such as a failure diagnosis program. The processing unit 60 includes a central processing unit (hereinafter called a CPU) 64, a main storage device 65, and an interface 66. This processing unit 60 is connected to the input device 61, output device 62, and auxiliary storage device 63 via the interface 66.

In this embodiment, the execution results of various programs such as a failure diagnosis program are stored in a storage area reserved in the main storage device 65. Various programs are stored in the auxiliary storage device 63 in advance and, after that, are read into the main storage device 65 for execution by the CPU 64. The execution of various programs by the CPU 64 implements various functions that will be described later.

Although an example, in which each information terminal of the failure diagnostic system is implemented by a general-purpose information processing device and software, is described in this embodiment, the information terminal may be implemented by hardware that includes a hard-wired logic or by such hardware and a pre-programmed general-purpose information processing device.

Although the failure diagnostic system is described in this embodiment as a system that performs integrated processing, the present invention is not limited to such a system. The present invention may be configured in such a way that the system is included in another information processing system so that it works as a part of that system. In addition, the present invention may be implemented by replacing a part of each information terminal function, by dividing the function into smaller units, or by combining the function with another function.

Next, the function configuration of the information terminals 11 to 14 of the failure diagnostic system and the data held by the information terminals 11 to 14 are described.

As shown in FIG. 2, the configuration modules 11 to 14 of the failure diagnostic system in this embodiment include processing devices 31 to 38 that are implemented by executing various programs in each processing device and storage units 41 to 48 in which various types of data are stored.

The processing devices include an input-information management unit 31 that manages alarm information generated at a failure occurrence time, a notification received from the user, and the relation of a diagnostic decision tree corresponding to the alarm information and the notification, a diagnostic decision tree information management unit 32 that manages the diagnostic decision tree information created by configuring an action task candidate required for repairing a failure symptom and the diagnostic task information for identifying the candidate into a tree structure with the preceding/following link information added, an optimal task computation unit 33 that computes a task for minimizing the expected repair time, which is an expected time required for the repair, in the diagnostic decision tree, a repair probability update unit 34 that updates the repair probability based on the result of performed diagnosis/action tasks, a measures-task information management unit 35 that manages the task recording information on a measures task, a sensor data management unit 36 that manages data acquired from the sensors on a target device, an alarm data management unit 37 that receives alarm information when the sensor data indicates an abnormality, and a failure diagnosis result output unit 38 that outputs the information for supporting the operator's failure diagnostic task on the measures task direction terminal.

Each of the functional units 31 to 38, implemented by the processing device, functions by executing various programs in the CPU 64 as described above. The detailed operation of the functional units will be described sequentially in the description of the processing flow.

The storage units include an input-information storage unit 41 that stores alarm information generated at failure time, a keyword included in a notification received from the user, and correspondence information on a diagnosis failure tree corresponding to the alarm information and the notification, a diagnostic decision tree master information storage unit 42 that stores a diagnostic decision tree that includes an action task required for repairing a failure symptom and diagnostic task information for identifying the action task, a repair probability storage unit 43 that stores the result generated by updating the repair probability based on the result of an performed diagnosis/action task, an optimal task information storage unit 44 that stores an optimal task computed by the optimal task computation unit 33, a basic configuration block storage unit 45 that stores the basic configuration block information for computing an optimal task, a measures-task information storage unit 46 that stores task recording information on a measures task, a sensor data storage unit 47 that stores data on the sensors installed for monitoring the operating state of a target device, and an alarm data storage unit 48 that stores data on an alarm that is sent when the sensor data indicates an abnormal value.

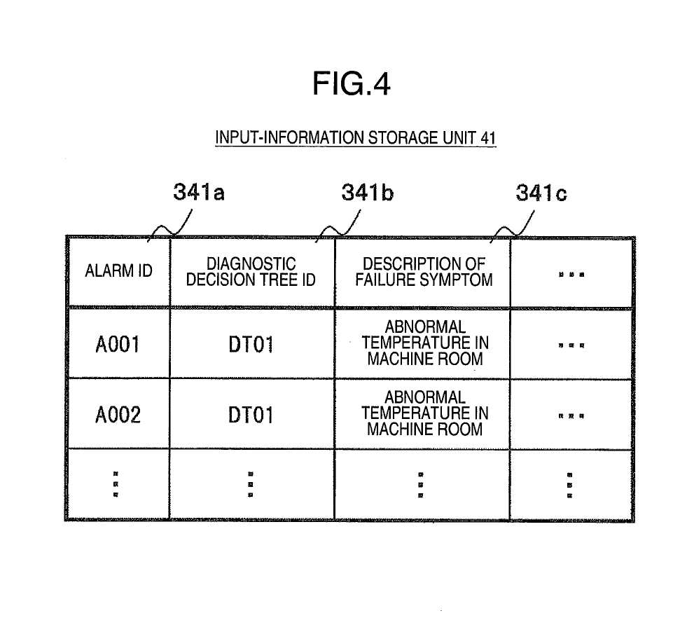

As shown in FIG. 4, the input-information storage unit 41 has an alarm ID field 331a that stores an alarm ID identifying a failure alarm issued by a measures-target device, a diagnostic decision tree ID field 331b, and a failure symptom description field 331c.

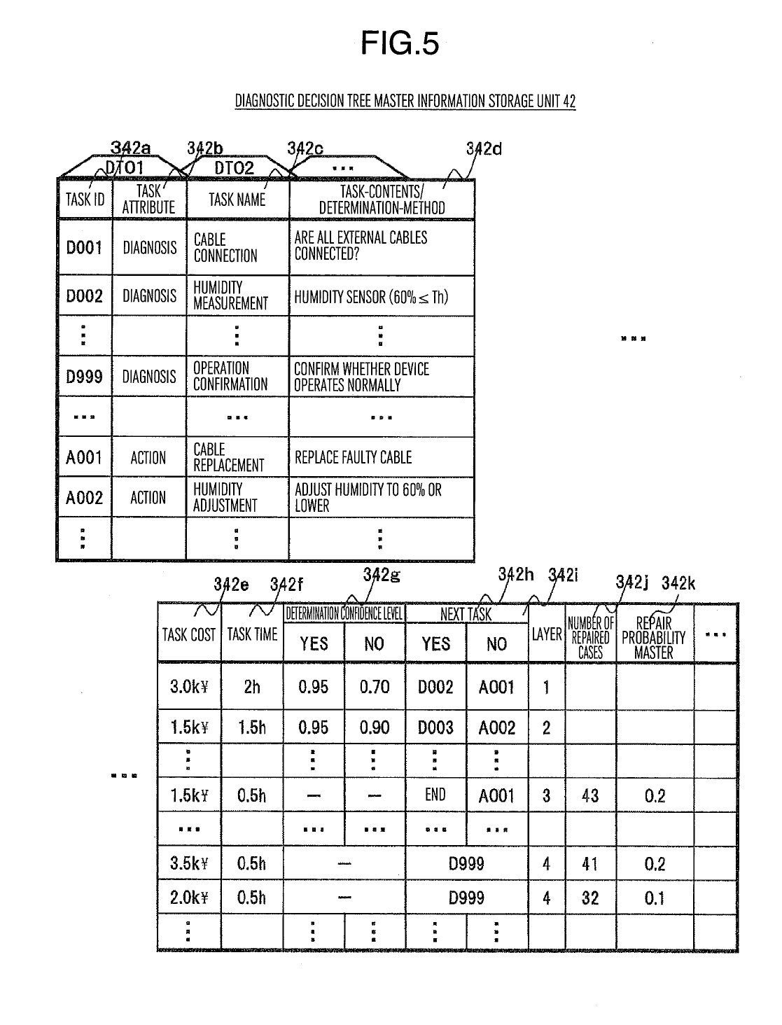

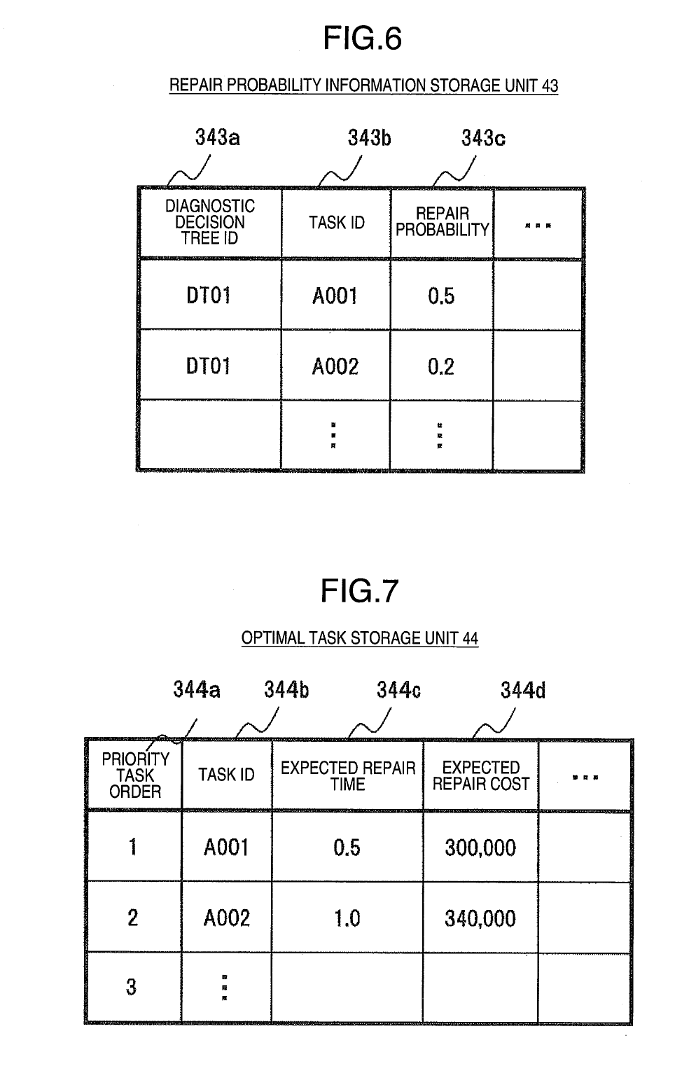

As shown in FIG. 5, the diagnostic decision tree master information storage unit has a task ID field 342a, a task attribute field 342b, a task name field 342c, a task-contents/determination-method field 342d, a task cost field 342e, a task time field 342f, a determination confidence level field 342g, a next task field 342h, a layer field 42i, a number-of-repaired-cases field 342j, and a repair probability master field 342k. As shown in FIG. 6, the repair probability storage unit 43 has a diagnostic decision tree ID field 343a, a task ID field 343b, and a repair probability field 343c.

As shown in FIG. 7, the optimal task storage unit 44 has a priority task order field 344a, a task ID field 344b, an expected repair time field 344c, and an expected repair cost field 344d.

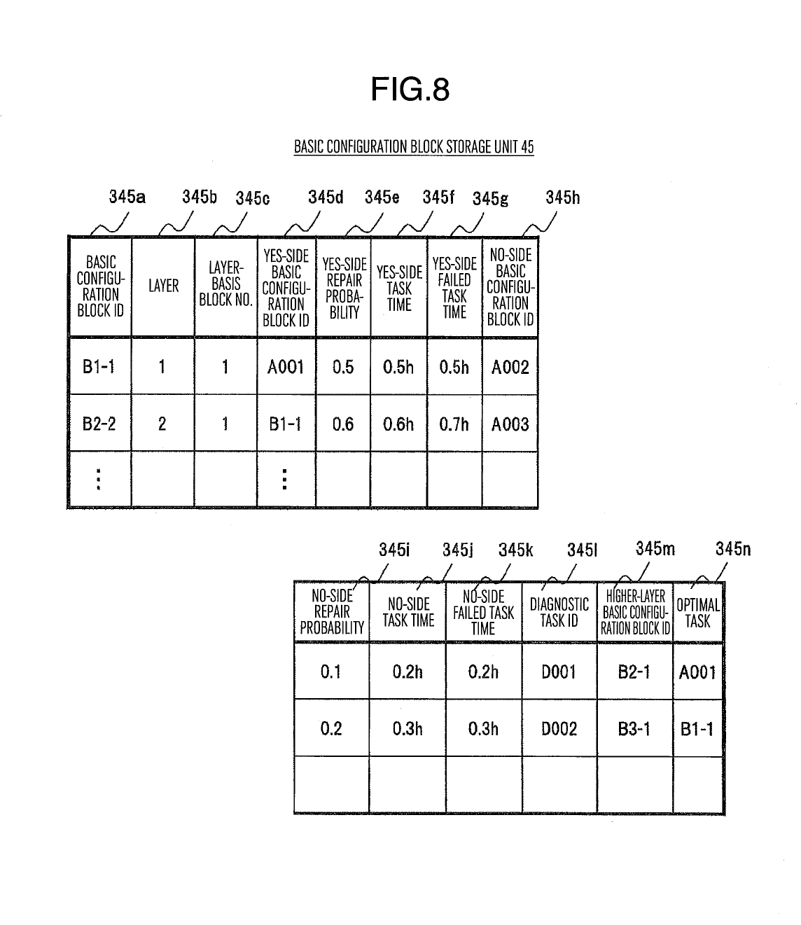

As shown in FIG. 8, the basic configuration block storage unit 45 has a basic configuration block ID field 345a, a layer field 345b, a layer-basis block No. field 345c, a Yes-side basic configuration block ID field 345d, a Yes-side repair probability field 345e, a Yes-side task time field 345f, a Yes-side failed task time field 345g, a No-side basic configuration block ID field 345h, a No-side repair probability field 345i, a No-side task time field 345j, a No-side failed task time field 345k, a diagnostic task ID field 345l, a higher-layer basic configuration block ID field 345m, and an optimal task field 345n.

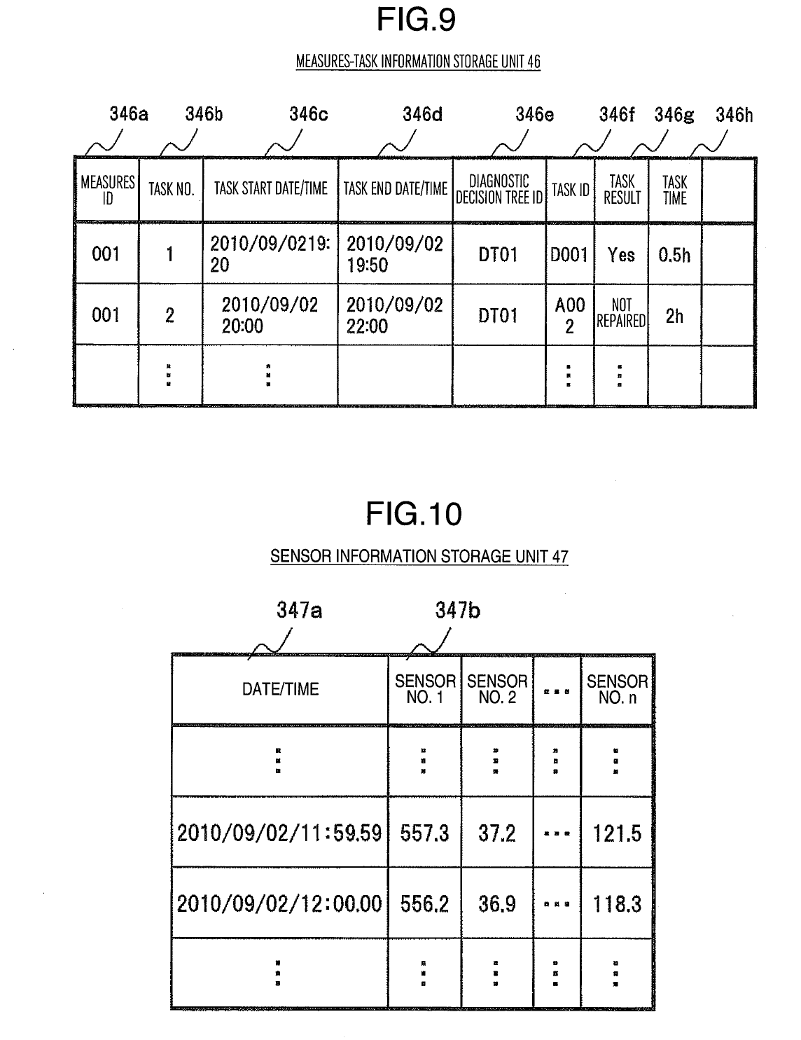

As shown in FIG. 9, the measures-task information storage unit 46 has a measures ID field 346a, a task No. field 346b that stores the order of a task the operator has performed, a task start date/time field 346c, a task end date/time 346d, a diagnostic decision tree ID field 346e, a task ID field 346f, a task result field 346g, and a task time field 346h.

As shown in FIG. 10, the sensor data storage unit 47 has a date/time field 347a and a sensor value field 347b.

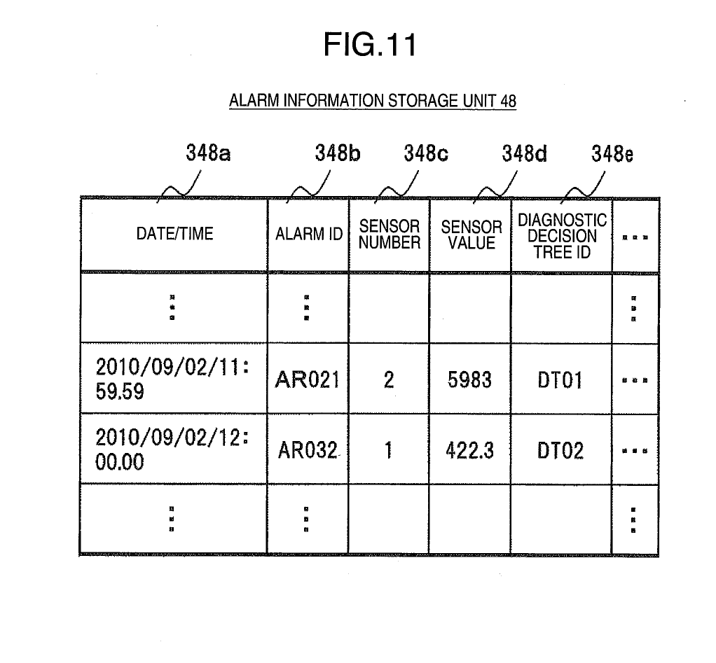

As shown in FIG. 11, the alarm information storage unit 48 has a date/time field 348a, an alarm ID field 348b, a sensor number field 348c, a sensor value field 348d, and a diagnostic decision tree ID field 348e.

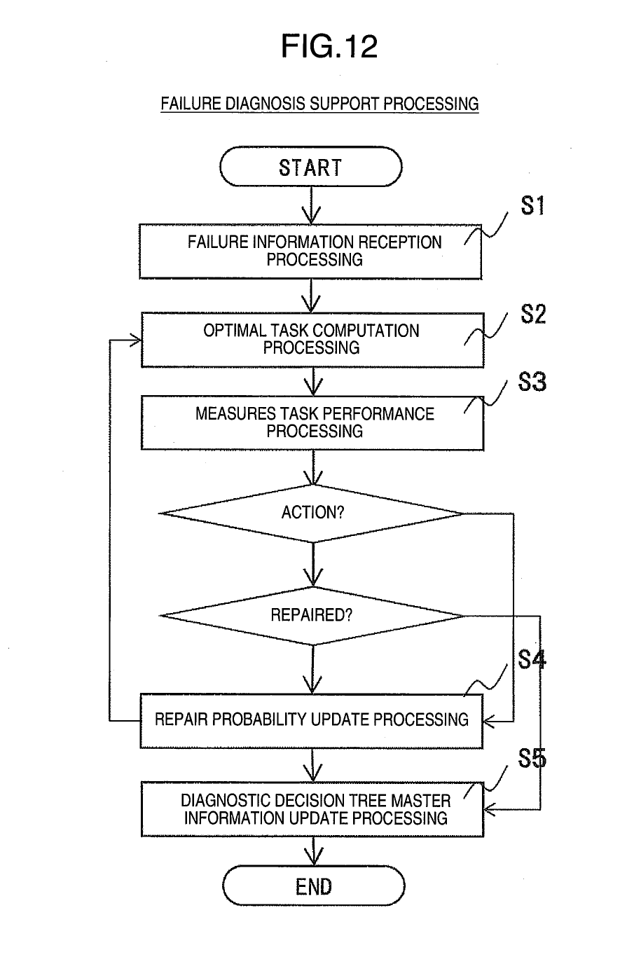

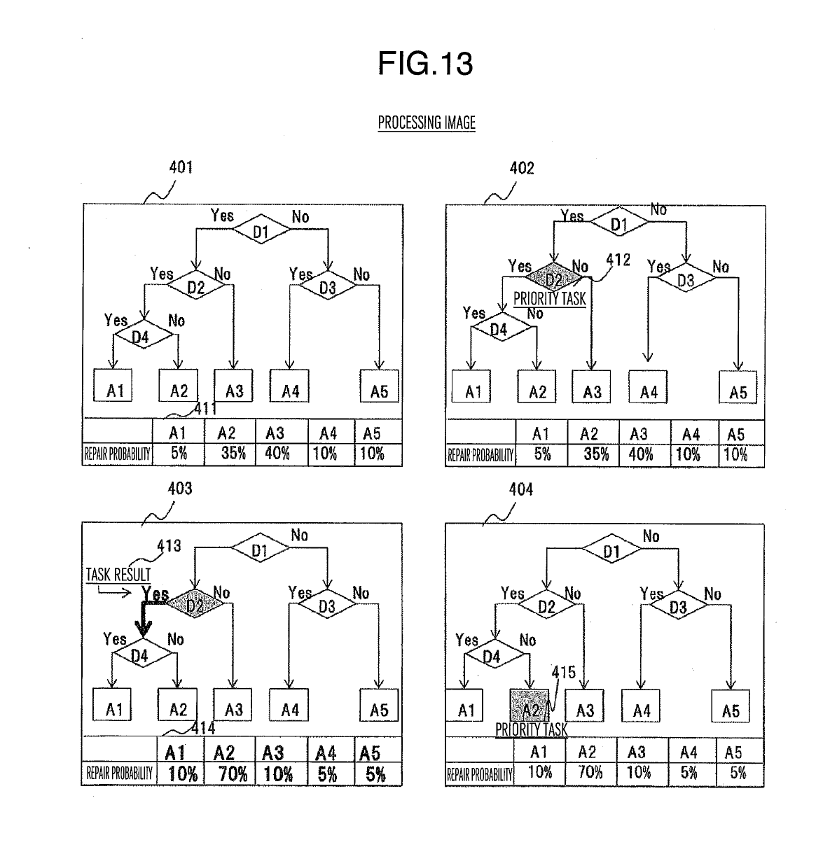

As shown in FIG. 12, the processing performed in the measures task-directing system includes the failure information reception processing Si in which, based on the contents of received information such as an alarm sent from the measures-target device at a failure generation time or a notification sent from the user, a diagnostic decision tree corresponding to the received information is selected; the optimal task sequence computation processing S2 in which an optimal task sequence is computed based on the repair probability, task time, and cost; the measures task performance processing S3 in which the performed measures task is stored; the repair probability update processing S4 in which the repair probability is updated based on the measures task result; and the diagnostic decision tree master information update processing S5 in which the task time master, determination confidence level master, and number-of-repaired-cases master are updated based on the result of the performed measures task. The performance result of the measures task-directing system is output to the measures task direction terminal to present it to the operator or the operator. The flow of the processing contents is described with reference to FIG. 13. In the failure information reception processing S1, the corresponding diagnostic decision tree is selected based on the received information (401). At this time, each action has the repair probability computed from the past action result (repaired, not repaired) (411). Next, in the measures-task sequence computation processing S2, an optimal priority task is presented based on the repair probability and the task time of each measures task (402, 412). The operator performs the task while referencing this result and, in the measures task performance processing S3, the task result is stored (403, 413) and, in the repair probability update processing S4, the repair probability of each action is updated based on the task result (414). Next, in the optimal task performance processing S3, a priority task is presented again based on the updated repair probability (404, 415). In this manner, the repair probability is updated each time measures are performed until the device is repaired and priority tasks are serially presented. The processing contents described above are described more in detail with reference to the flowcharts.

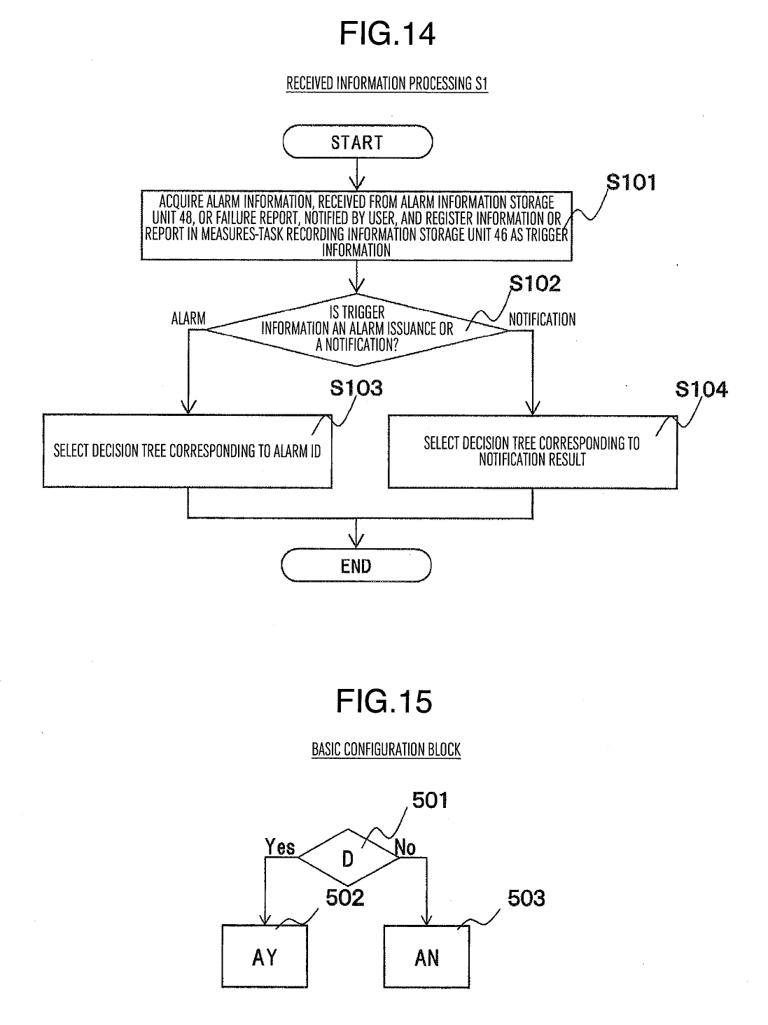

The processing flow of the failure information reception processing S1 is described with reference to the flowchart shown in FIG. 14. First, for alarm information received from the alarm information storage unit 48 or a failure report notified by the user, the input-information management unit 31 assigns a measures ID to the information or report for which a task will be generated, registers the information or report in the measures-task information storage unit 46 as the trigger information (S101), and determines whether the trigger information is an alarm issuance or a notification from the user (S102).

If the trigger information is an alarm issuance, the input-information management unit 31 references the alarm data storage unit and registers the selection result of a diagnostic decision tree, corresponding to the alarm ID, for the measures ID in the measures-task information storage unit 35 (S103). If the trigger information is a notification from the user, the input-information management unit 31 registers the selection result of a diagnostic failure tree corresponding to the notification keyword in the measures-task information storage unit 35 (S104).

Conventionally, the diagnostic processing using a diagnostic decision tree is started from the highest layer diagnostic task. There is a problem with this method in that a considerable time, or cost, is required to follow the diagnostic decision tree and reach an action task that repairs the failure. To solve this problem, the optimal task computation processing S2 is provided to find a position where the diagnostic processing is started from a diagnostic task or an action task that is considered optimal.

To do so, the optimal task computation processing S2 is performed with focus on a basic configuration block by combining the basic configuration elements of a diagnostic decision tree, such as a diagnostic task and an action task, as shown in FIG. 15. A basic configuration block is configured by three tasks, one diagnostic task (two-branch determination processing, Yes or No) and two action tasks, in the lowest layer and its immediate upper layer of the diagnostic decision tree. The three tasks are represented by the symbols as follows: D for the diagnostic task in the higher layer, AY for the task on the Yes-side in the lower layer, and AN for the task on the No-side in the lower layer. One basic configuration block is thought of as one representative action task that is below a diagnostic task in the next higher layer and, in this way, higher-layer basic configuration blocks are recursively configured. As a result, a basic configuration block is configured in such a way that basic configuration blocks, including the diagnostic task in highest layer, are hierarchically structured.

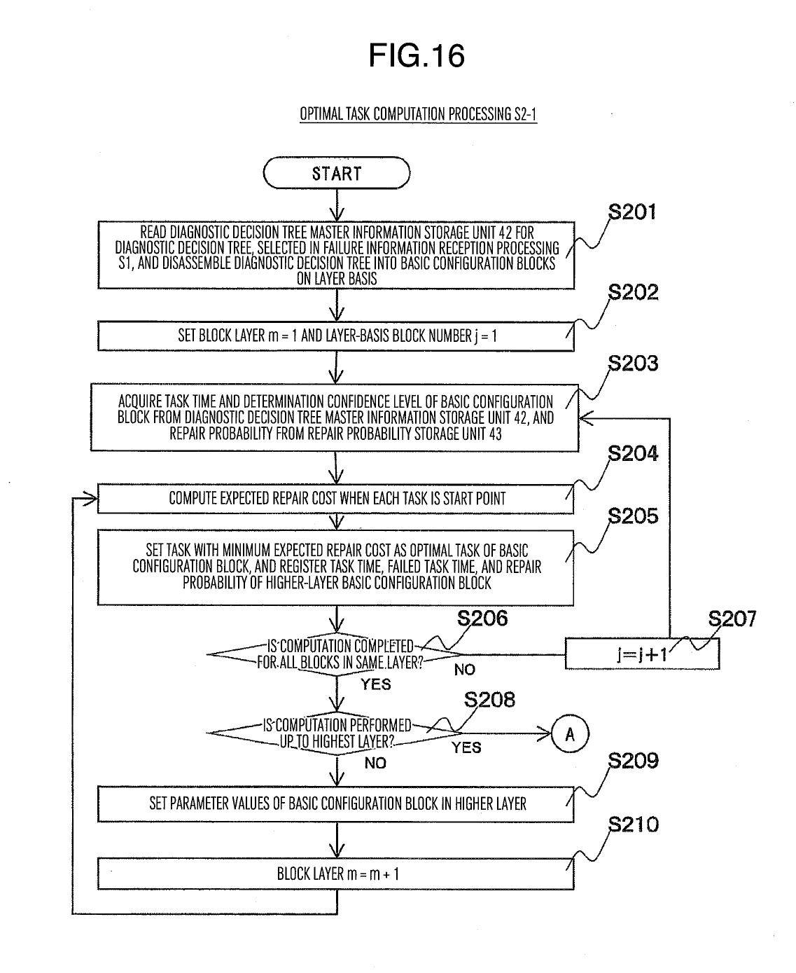

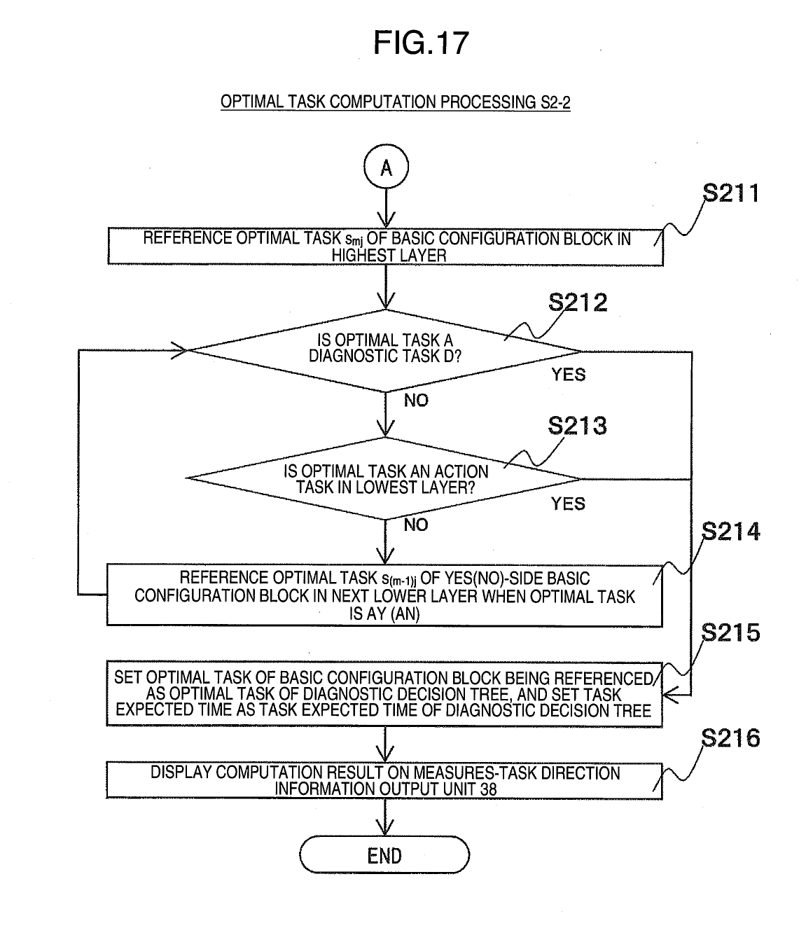

The processing flow of the optimal task computation processing S2 is described below with reference to the flowcharts shown in FIG. 16 and FIG. 17. First, for the diagnostic decision tree selected in the failure information reception processing S1, the diagnostic decision tree master information storage unit 42 is read, the diagnostic decision tree is disassembled into basic configuration blocks on a hierarchical basis as described above, and the basic configuration block ID 345a, Yes-side basic configuration block ID 345d, No-side basic configuration block ID 345h, and the diagnostic task ID 345l are stored in the basic configuration block storage unit 48 (S201).

Next, the value of 1 is assigned as the initial value of the block layer (m) that represents a layer of the basic configuration block, and the value of 1 is assigned as the initial value of the layer-basis block number (j). Here, the block layer (m) is defined as 1 for the lowest layer of the diagnostic decision tree and is increased as the layer becomes higher. The layer-basis block number (j) is a serial number assigned to each of the basic configuration blocks in each layer (202).

Next, for the selected basic configuration block (m, j), the task time, the repair probability, and the determination confidence level are acquired from the diagnostic decision tree master information storage unit 42 using the configuration element task IDs 345d, 345h, and 345l, registered in the basic configuration block storage unit 48, as the search key. The determination confidence level refers to the probability with which Yes is selected when a repair action is on the Yes-side in a diagnostic task or the probability with which No is selected when a repair action is on the No-side. The determination confidence level is set statistically based on the determination results and appropriate repair actions of each diagnostic task included in the past task results (log data). If there is no past result, the initial values are set as necessary. The determination confidence level is also the value of the determination confidence level of each diagnostic task that is set based on the experience of the operator who worked on each diagnostic task. If the Yes(No)-side basic configuration block is an action task, the repair probability, acquired from the diagnostic decision tree master information storage unit 42, is stored in the Yes(No)-side repair probability in the basic configuration block storage unit, and the task time, acquired from the diagnostic decision tree master information storage unit 42, is stored in the Yes(No)-side task time and the Yes(No)-side failed task time (S203).

Next, the expected repair time (EC_{AY}, EC_{AN}, EC_{D}), which will be required if each of the tasks AY, AN, and D (configuration elements of the selected basic configuration block (m, j)) is started first, is computed (S204).

The expected repair time when one of the tasks of a basic configuration block is performed first is computed as described below.

All routes for processing the diagnostic task D (501) and the action tasks AY(502) and AN(503), which are the configuration elements of the basic configuration block shown in FIG. 15, are defined as eight routes, [1] to [8], given below. EC_{AY}, EC_{AN}, and EC_{D} are computed respectively by the computation expressions given below, considering the possibility that each of them passes along the diagnostic processing routes [1] to [8].
[1] Expected repair time of {AY task is performed→Repaired and terminated}

$${EC}_{1} = ( \frac{{P}_{Y}}{{P}_{Y} + {P}_{N}} ) \cdot ( {C}_{{A}_{Y}} ) \qquad [ MATH . 1 ]$$

where, P_{Y} is the repair probability of the action task AY, and P_{N} is the repair probability of the action task AN.
[2] Expected repair time of {AY task is performed→Not repaired, AN task is performed→Repaired and terminated}

$${EC}_{2} = ( 1 - \frac{{P}_{Y}}{{P}_{Y} + {P}_{N}} ) \cdot ( {C}_{{A}_{Yng}} + {C}_{{A}_{N}} ) \qquad [ MATH . 2 ]$$

where, C_{AYng} is the Yes-side failed task time 345g that is the expected repair time when the device is not repaired by AY and is stored in the basic configuration block 45. The computation method for C_{AYng} will be described later.

Therefore, the expected repair time EC_{AY}, which will be required when the AY task is started first, is computed by the expression given below.

### [MATH. 3]

EC_{A}_{_{Y}}=EC₁+EC₂
[3] Expected repair time of {AN task is performed→Repaired and terminated}

$${EC}_{3} = ( \frac{{P}_{Y}}{{P}_{Y} + {P}_{N}} ) \cdot ( {C}_{{A}_{N}} ) \qquad [ MATH . 4 ]$$

[4] Expected repair time of {AN task is performed→Not repaired, AY task is performed→Repaired and terminated}

$${EC}_{4} = ( 1 - \frac{{P}_{Y}}{{P}_{Y} + {P}_{N}} ) \cdot ( {C}_{{A}_{Y}} + {C}_{{A}_{N} ng} ) \qquad [ MATH . 5 ]$$

where, C_{ANng} is the No-side failed task time 345k that is the task time when the device is not repaired by AN. Therefore, the expected repair time EC_{AN}, which will be required when the AN task is started first, is computed by the expression given below.

### [MATH. 6]

EC_{A}_{_{N}}=EC₃+EC₄
[5] Expected time of {D task is performed→AY task is performed→Repaired and terminated}

$${EC}_{5} = ( {p}_{DY} ) \cdot ( \frac{{P}_{Y}}{{P}_{Y} + {P}_{N}} ) \cdot ( {C}_{D} + {C}_{{A}_{Y}} ) \qquad [ MATH . 7 ]$$

where, P_{DY} is the Yes-side determination confidence level of the diagnostic task D.
[6] Expected repair time of {D task is performed→AY task is performed→Not repaired, AN task is performed→Repaired and terminated}

$${EC}_{6} = ( 1 - {p}_{DN} ) \cdot ( \frac{{P}_{N}}{{P}_{Y} + {P}_{N}} ) \cdot ( {C}_{D} + {C}_{{A}_{Y} ng} + {C}_{{A}_{N}} ) \qquad [ MATH . 8 ]$$

[7] Expected repair time of {D task is performed→AN task is performed→Repaired and terminated}

$${EC}_{7} = ( {p}_{DN} ) \cdot ( \frac{{P}_{N}}{{P}_{Y} + {P}_{N}} ) \cdot ( {C}_{D} + {C}_{{A}_{N}} ) \qquad [ MATH . 9 ]$$

where, P_{DN} is the No-side determination confidence level of the diagnostic task D.
[8] Expected repair time of {D task is performed→AN task is performed→Not repaired, AY task is performed→Repaired and terminated}

$${EC}_{8} = ( 1 - {p}_{DY} ) \cdot ( \frac{{P}_{N}}{{P}_{Y} + {P}_{N}} ) \cdot ( {C}_{D} + {C}_{{A}_{Y}} + {C}_{{A}_{Nng}} ) \qquad [ MATH . 10 ]$$

Therefore, the expected repair time EC_{D}, which will required when the D task is started first, is computed by the expression given below.

### [MATH. 11]

EC_{D}=EC₅+EC₆+EC₇+EC₈

Next, one of the tasks AY, AN, and D, the expected repair time of which is the minimum, is determined as the optimal task, and the task ID of the optimal task is registered in the optimal task (sₘⱼ) 345n in the basic configuration block storage unit. The basic configuration block (m+1, p) in the higher layer of the basic configuration block (m, j) is identified from the higher-layer basic configuration block ID in the basic configuration block storage unit 45. It is determined, from the Yes-side basic configuration block ID and the No-side basic configuration block ID, in which basic configuration block, Yes side or No side, it is positioned. If it is positioned in the Yes-side basic configuration block, min{EC_{D}, EC_{AY}, EC_{AN}} is set in the Yes-side task time 345f, C_{D}+C_{AY}+C_{AN} is set in the Yes-side failed task time 348g if the optimal task is D and C_{AY}+C_{AN} if the optimal task is AY or AN, and P_{Y}+P_{N} is set in the Yes-side repair probability 348b. If it is positioned in the No-side basic configuration block, min{EC_{D}, EC_{AY}, EC_{AN}} is set in the No-side task time 348j, C_{D}+C_{AY}+C_{AN} is set in the No-side failed task time 348k if the optimal task is D and C_{AY}+C_{AN} if the optimal task is AY or AN, and P_{Y}+P_{N} is set in the No-side repair probability field 348k. (S205)

The expected repair time of the optimal task (Sₘⱼ) of the basic configuration block (m, j) is called the representative value of the basic configuration block (m, j). It is though that the basic configuration block in the next-higher layer is configured by the three tasks composed of the two representative values of two basic configuration blocks and one diagnostic task in the next-higher layer.

After that, a determination is made whether the value of the layer-basis block number j is the last number of that layer (S206). If the value of the layer-basis block number j is not the last number of the layer, j+1 is assigned to j and the processing is repeated from S203 to S207.

If the value of layer-basis block number j is the last number of that layer, a determination is made whether the block layer m is the highest layer, based on the higher-layer basic configuration block ID 345m of the basic configuration block storage unit 45. If the block layer m is not the highest layer, m+1 is assigned to the block layer m and the processing from S204 to S210 is repeated. If the block layer m is the highest layer, the optimal task sₘⱼ of the basic configuration block in the highest layer is referenced (S211) and a determination is made whether sₘⱼ is a diagnostic task D (S212).

If sₘⱼ is a diagnostic task D, sₘⱼ is set as the optimal task of the diagnostic decision tree (S215), the computation result is displayed on the measures-task direction information output unit 38 (216), and the optimal task computation processing S2 is terminated. If sₘⱼ is not a diagnostic task D, a determination is made whether sₘⱼ is the action task A_{1Y} or A_{1N} in the lowest layer (S213). If sₘⱼ is not the action task A_{1Y} or A_{1N} in the lowest layer, s₍ₘ₋₁₎ⱼ of the Yes-side block in the next lower layer is referenced if sₘⱼ is AY, s₍ₘ₋₁₎ⱼ of the No-side block in the next lower layer is referenced if sₘⱼ is AN, and the processing from S212 to 213 is repeated (S214).

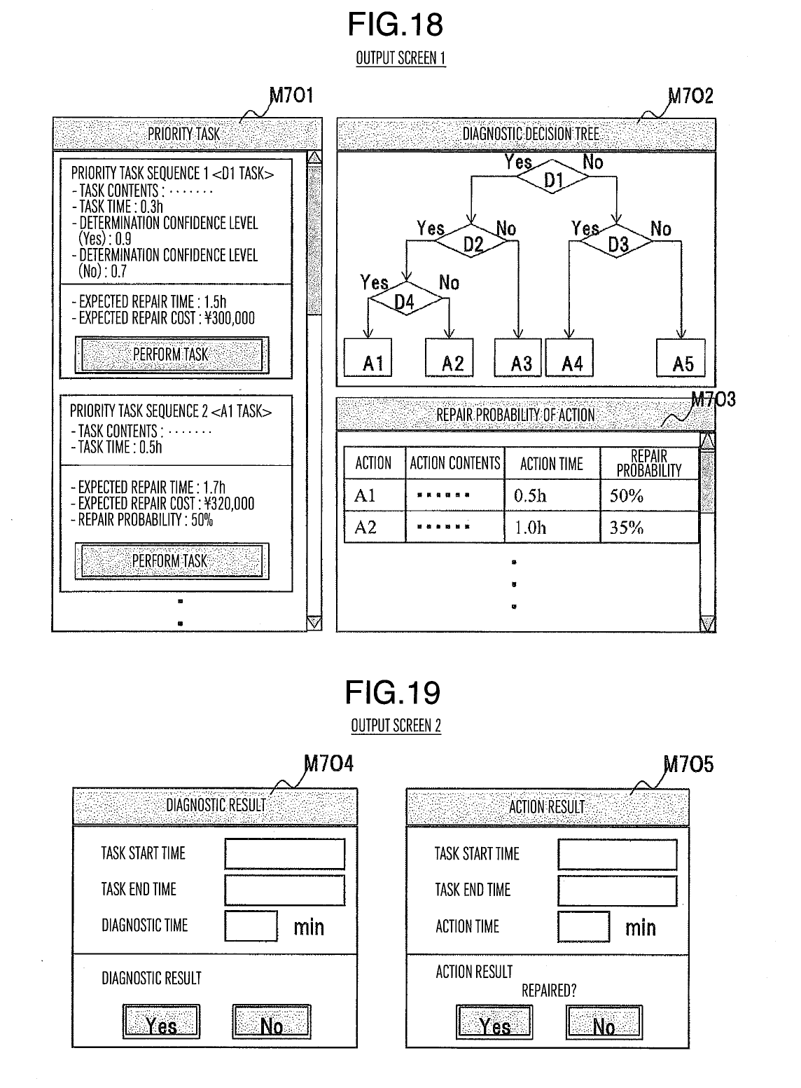

If sₘⱼ is the action task A_{1Y} or A_{1N} in the lowest layer, sₘⱼ is set as the optimal task of the diagnostic decision tree (S215), the computation result is displayed on the measures-task direction information output unit 38, and the optimal task computation processing S2 is terminated. FIG. 18 shows an example of the output screen in this embodiment. The priority task sequence and the expected repair time when the processing is started from the priority task sequence (M701) and the repair probability of each action (M703) are output. The operator selects a performed task on the output screen and performs the task. When the task is terminated, the diagnosis start time, end time, time required for the diagnosis, and diagnostic result of the diagnosis are entered on the screen shown in FIG. 19 if a diagnosis is performed (M704). The start time, end time, time required for the diagnosis, and diagnostic result of the diagnosis are entered if an action is performed (M705).

At this time, in the measures task performance processing S3, the start time of the performed task, end time, task No. that is the task performance sequence, diagnostic decision tree ID, task ID, task time, and task result are stored in the measures-task information storage unit 45.

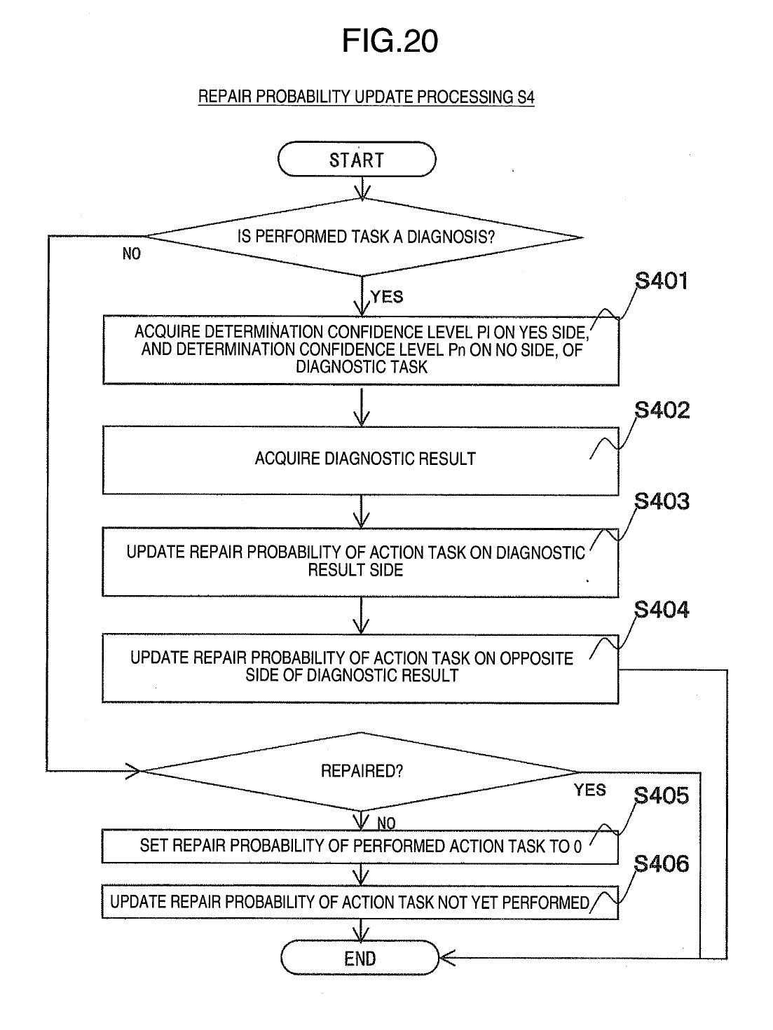

Although an example is described in this embodiment in which the task time is used as the evaluation index for computing the optimal task, the task cost may also be considered as the evaluation index. The user may select any one of the evaluation indexes. The processing flow of the repair probability update processing S4 is described with reference to the flowchart shown in FIG. 20. First, the repair probability update unit 34 acquires the ID of the performed task from the measures-task information storage unit 46. If the performed task is a diagnosis, the repair probability update unit 34 acquires the Yes-side determination confidence level and the No-side determination confidence level of the task ID from the diagnostic result and the diagnostic decision tree master information storage unit 42. If the determination result is Yes, the repair probability update unit 34 computes the repair probability P_{jnew} of the action task on the Yes side using the expression given below (S403).

$${P}_{j new} = {P}_{j} \cdot \frac{{P}_{DY}}{\begin{matrix}( \frac{\sum {P}_{Y}}{\sum {P}_{Y} + \sum {P}_{N}} ) \cdot {P}_{DY} + \\ ( \frac{\sum {P}_{N}}{\sum {P}_{Y} + \sum {P}_{N}} ) \cdot ( 1 - {P}_{DN} )\end{matrix}} . \qquad [ MATH . 12 ]$$

where, pj is the repair probability of the task to be updated, ΣP_{Y} is the sum of the repair probabilities on the Yes side, ΣP_{N} is the sum of the repair probabilities on the No side, P_{DY} is the determination confidence level on the Yes side, and P_{DN} is the determination confidence level on the No side.

The repair probability update unit 34 computes the repair probability P_{jnew} of the action task on the No side using the expression given below (S404).

$${P}_{j new} = {P}_{j} \cdot \frac{1 - {P}_{DN}}{\begin{matrix}( \frac{\sum {P}_{N}}{\sum {P}_{Y} + \sum {P}_{N}} ) \cdot {P}_{DN} + \\ ( \frac{\sum {P}_{Y}}{\sum {P}_{Y} + \sum {P}_{N}} ) \cdot ( 1 - {P}_{DY} )\end{matrix}} . \qquad [ MATH . 13 ]$$

If the determination result is No, the repair probability update unit 34 computes the repair probability P_{jnew} of the action task on the No side using the expression given below (S403).

$${P}_{j new} = {P}_{j} \cdot \frac{{P}_{DN}}{\begin{matrix}( \frac{\sum {P}_{N}}{\sum {P}_{Y} + \sum {P}_{N}} ) \cdot {P}_{DN} + \\ ( \frac{\sum {P}_{Y}}{\sum {P}_{Y} + \sum {P}_{N}} ) \cdot ( 1 - {P}_{DY} )\end{matrix}} . \qquad [ MATH . 14 ]$$

The repair probability update unit 34 computes the repair probability P_{jnew} of the action task on the Yes side using the expression given below (S404).

$${P}_{j new} = {P}_{j} \cdot \frac{1 - {P}_{DY}}{\begin{matrix}( \frac{\sum {P}_{Y}}{\sum {P}_{Y} + \sum {P}_{N}} ) \cdot {P}_{DY} + \\ ( \frac{\sum {P}_{N}}{\sum {P}_{Y} + \sum {P}_{N}} ) \cdot ( 1 - {P}_{DN} )\end{matrix}} . \qquad [ MATH . 15 ]$$

If the performed task is an action, the repair probability update unit 34 sets the repair probability of the performed action task to 0 (S405) and computes the repair probability P_{jnew} of the action task, not yet performed, using the expression given below (S406).

$${P}_{j new} = \frac{{P}_{j}}{\sum P} . \qquad [ MATH . 16 ]$$

where, Σp is the sum of the repair probabilities of actions not yet performed.

The repair probability update unit 34 stores the updated repair probability in the repair probability storage unit and terminates the processing. As described above, the repair probability update processing unit serially enters the task recording information on an action task to serially update the repair probability.

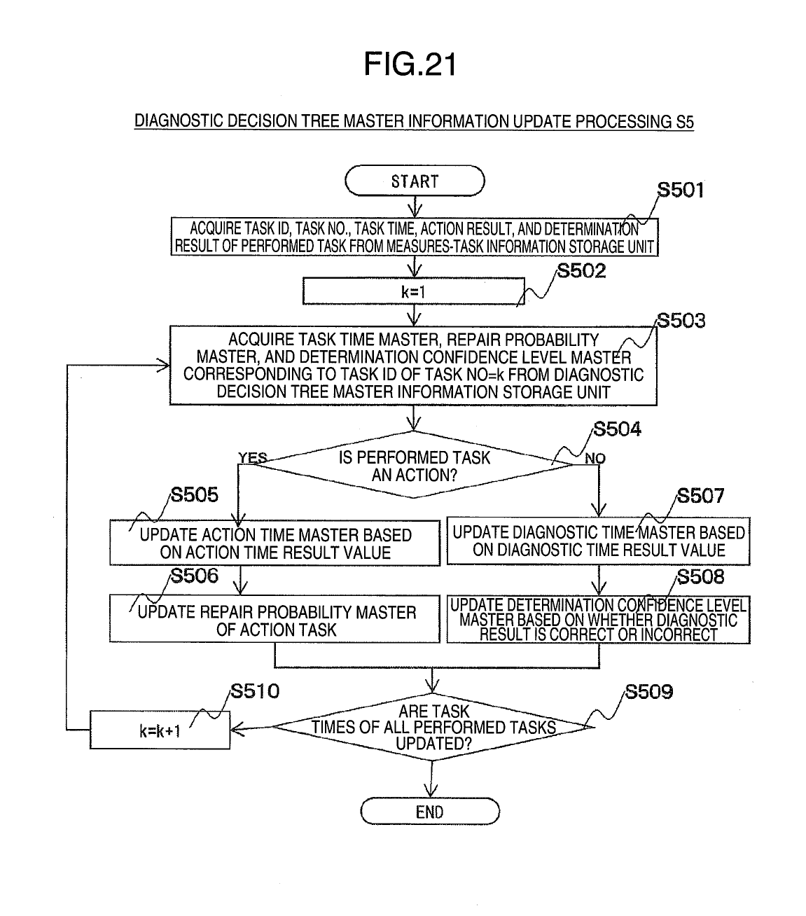

Next, the flow of the diagnostic decision tree master information update processing S5 is described with reference to the flowchart shown in FIG. 21. The task ID, task performance No., task time, and task result of the performed task are acquired from the measures-task information storage unit (S501), and k is set to 1 (S502). The task time master, repair probability master, and determination confidence level master corresponding to the task ID of the task No=k are acquired from the diagnostic decision tree master information storage unit (S503). If the performed task is an action, the action time master and the repair probability master are updated through the statistical processing, such as simple averaging, based on the actual action time and the action result (S505, S506). If the performed task is a diagnosis, the diagnostic time and the determination confidence level master are updated through statistical processing, such as simple averaging, based on the actual diagnostic time and diagnostic result (S507, S508). A confirmation is made if the task times of all performed tasks are updated (S509). If the task times of all performed tasks are not yet updated, k+1 is assigned to k (S510) and the processing from S503 to S510 is repeated. If the task times of all tasks are updated, the processing S5 is terminated.

As described above, the system according to the present invention updates the repair probability for an action each time a measures task is performed, and serially presents an optimal task sequence, thus reducing the downtime that might be generated by performing a measures task.

### Second Embodiment

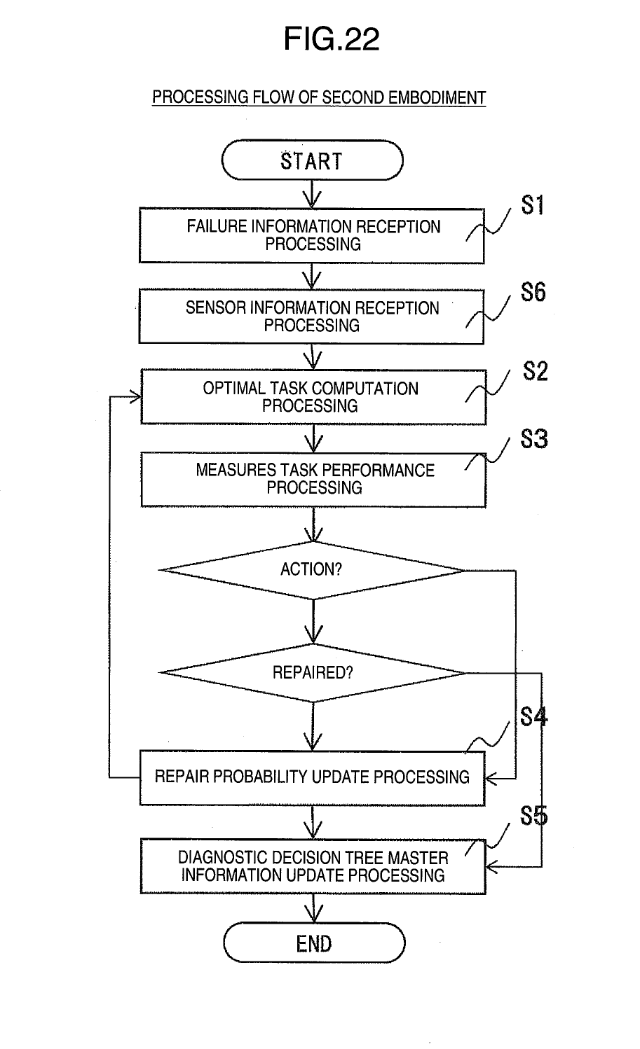

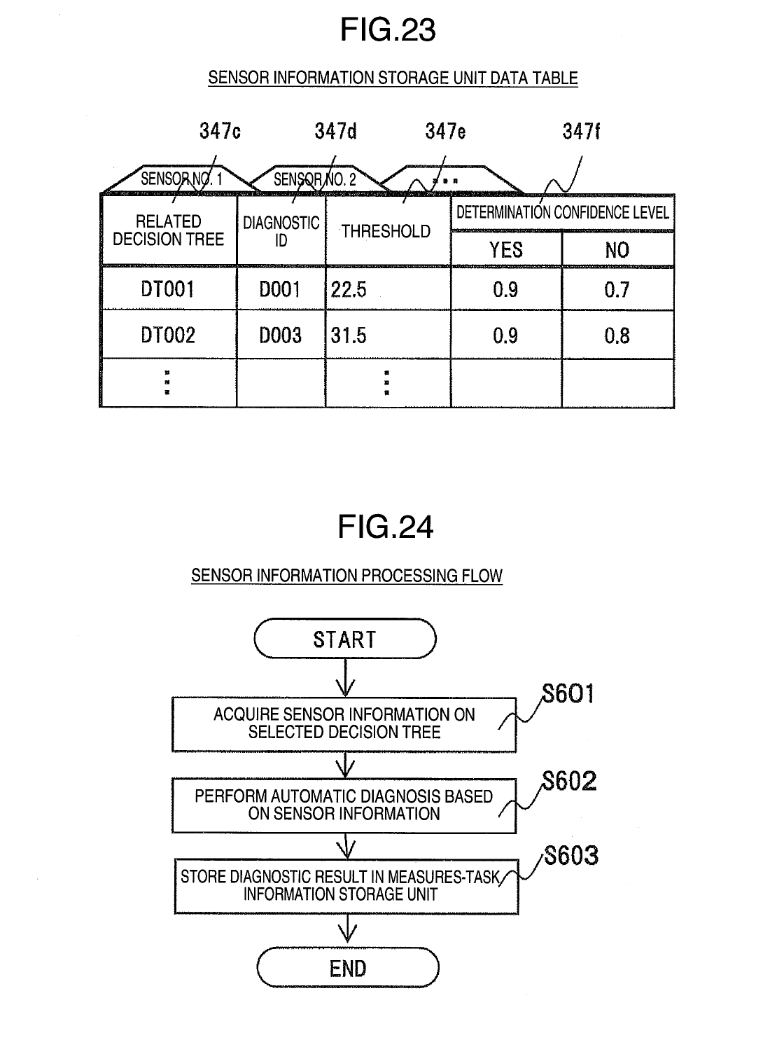

In this embodiment, an example of a system is described that uses not only a diagnostic result entered by an operator or an operator but also a diagnostic result that is information obtained from the sensor units of a measures-target device connected to the network 71. In addition to the system configuration in the first embodiment, the sensor information storage unit further includes a related decision tree ID field 347c, a diagnostic ID field 347d, a threshold field 347e, and a determination confidence level field 347f as shown in FIG. 22.

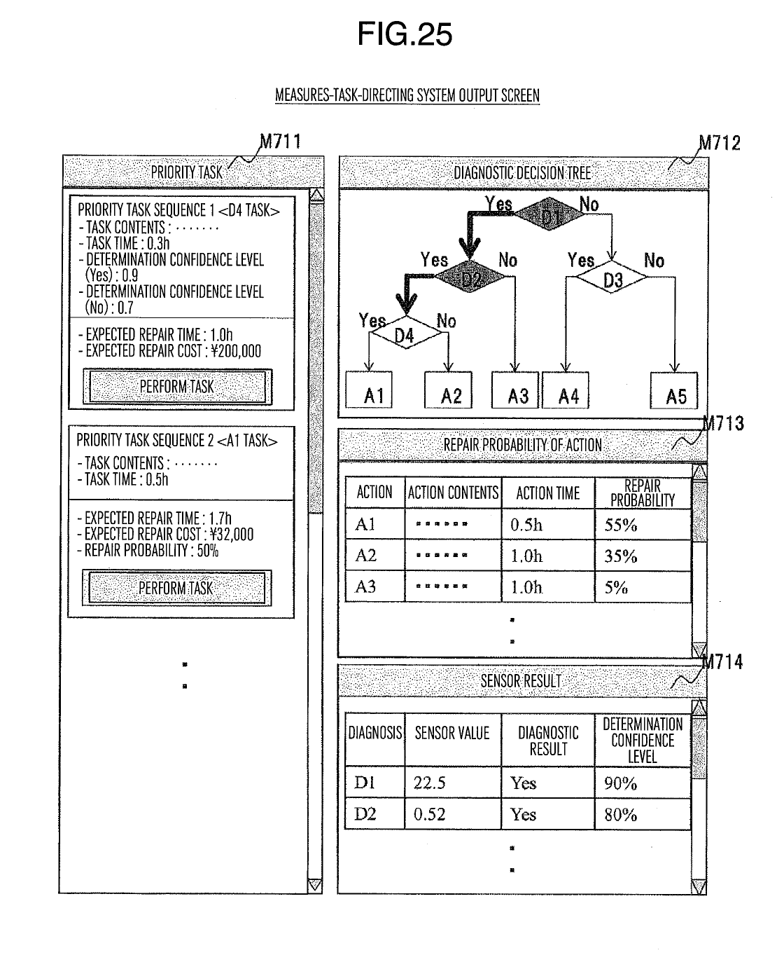

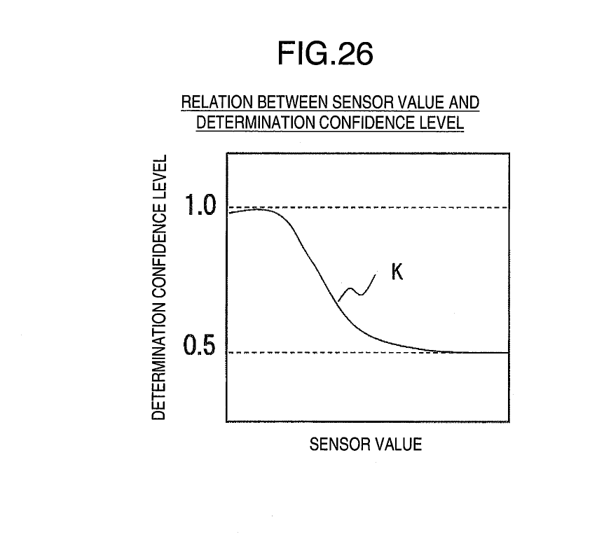

The processing flow in this embodiment is described with reference to the flowchart shown in FIG. 22. For the processing in FIG. 22, the processing that has the same reference numeral as that in the processing in FIG. 12 described above is omitted. The flow of the sensor information reception processing S6 is described with reference to the flowchart shown in FIG. 24. The sensor information on the decision tree, selected in the failure information reception processing Si, is acquired from the sensor information storage unit (S601), a diagnostic task is determined from the sensor information based on the threshold stored in the sensor information storage unit (S602), the diagnostic result is stored in the measures-task information storage unit (S603), and the processing is terminated. An example of the output screen in this embodiment is shown in FIG. 25. In addition to the information shown in FIG. 18, the sensor value related to the selected diagnostic decision tree, diagnostic result produced by the sensor, and the determination confidence level are output (M714). At this time, by finding, in advance, the relation (k) between the sensor value and the determination confidence level from experiments or past results as shown in FIG. 26, the determination confidence level in each diagnostic task in the diagnostic decision tree may be set as the function of sensor values.

### REFERENCE SIGNS LIST

11-14 . . . Configuration module of measures task-directing system

21-27 . . . Data sent and received between units

31-38 . . . Operation functions

41-48 . . . Storage functions

60 . . . Processing device

61 . . . Input device

62 . . . Output device

63 . . . Auxiliary storage device

64 . . . Central processing unit (CPU)

65 . . . Main storage device

66 . . . Interface

71 . . . Network

341a-341c, 342a-342k, 343a-343c, 344a-344d, 345a-345n, 346a-346h, 347a-347f, 348a-348c . . . Fields of storage units

401-404, 411-415 . . . Processing operation of diagnostic decision tree

501-503 . . . Elements of basic configuration block

S101-S104, S201-S216, S401-S406, S501-S510, S601-S603 . . . Processing steps

M701-M705, M711-M714 . . . Sub-screen of output screen

1. A task-directing system that presents a task for repairing a device, said task-directing system characterized by comprising:
a storage unit that includes a diagnostic information storage unit that stores diagnostic information composed of a plurality of layers each including a diagnostic task and an action task for repairing and a task time or a task cost of each task; and a repair probability storage unit that stores a repair probability, said repair probability being a probability with which the device will be repaired by performing each action task;
a processing unit that includes a repair probability update unit that updates the repair probability stored in said repair probability storage unit based on a result of the diagnostic task that is received; and an optimal task computation unit that computes a priority task from the updated repair probability and the task time or the task cost of each task; and
an output unit that outputs information on the priority task computed by said optimal task computation unit.

2. The task-directing system according to claim 1 characterized in that, in said processing unit, the update of the repair probability by said repair probability update unit is repeatedly performed based on a result of the priority task computed by said optimal task computation unit.

3. The task-directing system according to claim 1 characterized in that, in said repair probability update unit, the repair probability is updated using a determination confidence level for a determination of the diagnostic task.

4. The task-directing system according to claim 3 characterized in that the determination confidence level is set for each diagnostic task based on past task results.

5. The task-directing system according to claim 1 characterized in that the result of the diagnostic task is entered into said task-directing system based on information from a sensor of a measures-target device connected to said task-directing system.

6. The task-directing system according to claim 3 characterized in that the result of the diagnostic task is entered into said task-directing system based on information from a sensor of a measures-target device connected to said task-directing system and the determination confidence level uses a function of a value from said sensor.

7. The task-directing system according to claim 1 characterized in that
said optimal task computation unit computes an expected repair time and an expected repair cost when the priority task is performed and
said output unit outputs the expected repair time and the expected repair cost when the priority task is performed.

8. A task-directing method, for use in a task-directing system including a storage unit, a processing unit, and an output unit, for presenting a task for repairing a device, said task-directing method characterized by comprising the steps of:
selecting diagnostic information composed of a plurality of layers each including a diagnostic task and an action task for repairing, based on information on a received device failure, said diagnostic information being stored in said storage unit;
computing, in said processing unit, a priority task from a task time or a task cost of each task and a repair probability, said repair probability being a probability with which the device will be repaired by performing each action task;
updating the repair probability based on a result of performing the priority task; and
outputting, in said output unit, information on the computed priority task.

9. The task-directing method according to claim 8 characterized in that the update of the repair probability is repeatedly performed based on a result of the computed priority task.

10. The task-directing method according to claim 8 characterized in that the repair probability is updated using a determination confidence level for a determination of the diagnostic task.

11. The task-directing method according to claim 10 characterized in that the determination confidence level is set for each diagnostic task based on past task results.

12. The task-directing method according to claim 8 characterized in that the result of performing the priority task is based on information from a sensor of a measures-target device connected to said task-directing system.

13. The task-directing method according to claim 10 characterized in that the result of performing the priority task is based on information from a sensor of a measures-target device connected to said task-directing system and the determination confidence level uses a function of a value from said sensor.

14. The task-directing method according to claim 8 characterized in that said processing unit computes an expected repair time and an expected repair cost
when the priority task is performed and said output unit outputs the expected repair time and the expected repair cost
when the priority task is performed.
